(19) United States
(12) Patent Application Publication
(10) Pub. No.: US 2007/0006059 A1
(43) Pub. Date: Jan. 4, 2007

(54) Repeating panel sets

(75) Inventors: Robert M. Dolin, Seattle, WA (US); Allan J. Fink, Seattle, WA (US); Matthew D. Wood, Bellevue, WA (US); Zhenjun Zhu, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/171,949

(22) Filed: Jun. 30, 2005

(51) Int. Cl. G06F 17/00; G06F 3/12

(52) U.S. Cl. 715/500; 715/530; 358/1.15

(57) ABSTRACT

A panel set is defined within a grid area. The grid area enclosing the panel set is then used to tile a sheet. Instead of defining each panel's position within an entire sheet, a single panel set is defined, and then that single panel set is tiled. The definitions for the panel sets may be stored externally from the program using the panel set definitions, thereby allowing definitions to be added more easily as compared to hard-coding the definitions within the program itself. The number of panel sets tiled within a sheet may be determined based on the size of the sheet being printed on. For example, more business cards may be tiled within a legal size sheet as compared to a standard 8.5×11 sheet.

### BACKGROUND

There are a variety of different desktop publishing and graphic design software programs available that may be used to print and create a label, a CD cover, an envelope, a postcard, a greeting card, and the like. Typically, a template is used that relies on a specific style and type of paper provided by a paper manufacturer. There are literally hundreds of paper manufacturers as well as thousands of different styles developed by the paper manufacturers. It is difficult for a publishing or graphics program to keep up with and support all of these different paper products. Even when a program attempts to stay current with a company's products, there may be a significant lag time in incorporating new products within the program. For example, there may be a span of a year or two between releases of some publishing or graphics programs. During this time, it may not be possible to add new products to a program after the program's release.

### SUMMARY

Briefly stated, embodiments of the present invention are related to defining and creating repeating panel sets.

According to one aspect of the invention, a panel set is defined within a grid area. The grid area enclosing the panel set is then used to tile a sheet. Instead of defining each panel's position within an entire sheet, a single panel set is defined.

According to another aspect of the invention, the panel set definitions are stored externally from the program that uses the panel set definitions. Externally storing the definitions allows future definitions to be added more easily as compared to hard-coding the definitions within the program itself. The panel set definitions may also be stored in many ways, such as: using XML, a database, spreadsheet, delimited file, and the like.

According to another aspect of the invention, the number of panel sets tiled within a sheet may be determined based on the size of the sheet being printed on. For example, more business cards may be tiled within a legal size sheet as compared to a standard 8.5×11 sheet.

### BRIEF DESCRIPTION OF THE DRAWINGS

FIG. 1 illustrates an exemplary computing device;

FIG. 2 is a functional block diagram generally illustrating a repeating panel system;

FIG. 3 shows a basic XML description for standard paper;

FIG. 4 illustrates defining grids of master panels;

FIG. 5 shows a definition for a greeting card; and

FIG. 6 illustrates a process for tiling a sheet with repeating panels, in accordance with aspects of the present invention.

### DETAILED DESCRIPTION OF THE PREFERRED EMBODIMENT

Embodiments of the present invention are related to defining and creating repeating panel sets. A panel set may be defined within a grid area that is then used to tile a sheet. Instead of defining each panel's position and dimensions for an entire sheet, a single panel set is defined. According to one embodiment, XML is used to store panel set definitions. The XML definition for the panel sets may be stored externally allowing definitions to be added more easily as compared to hard-coding the definitions within the program itself.

Repeating Panel Sets

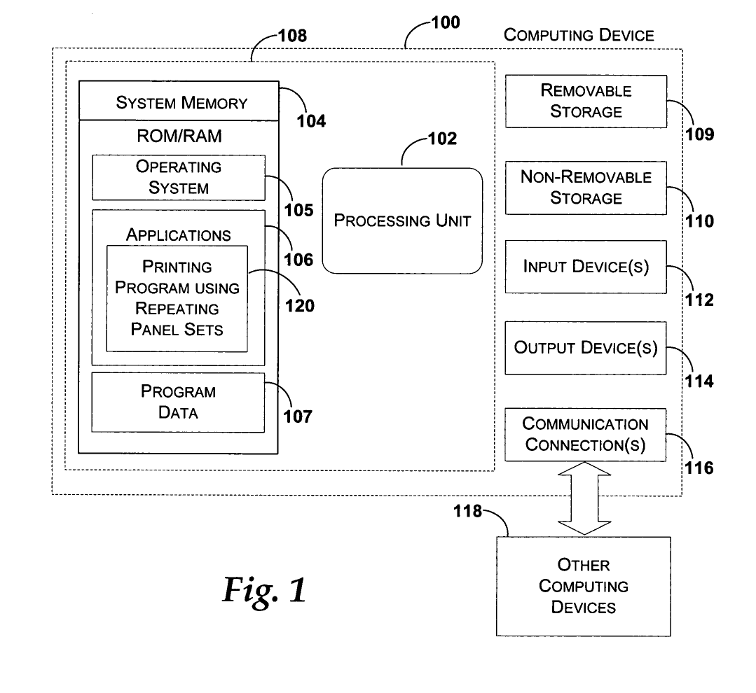

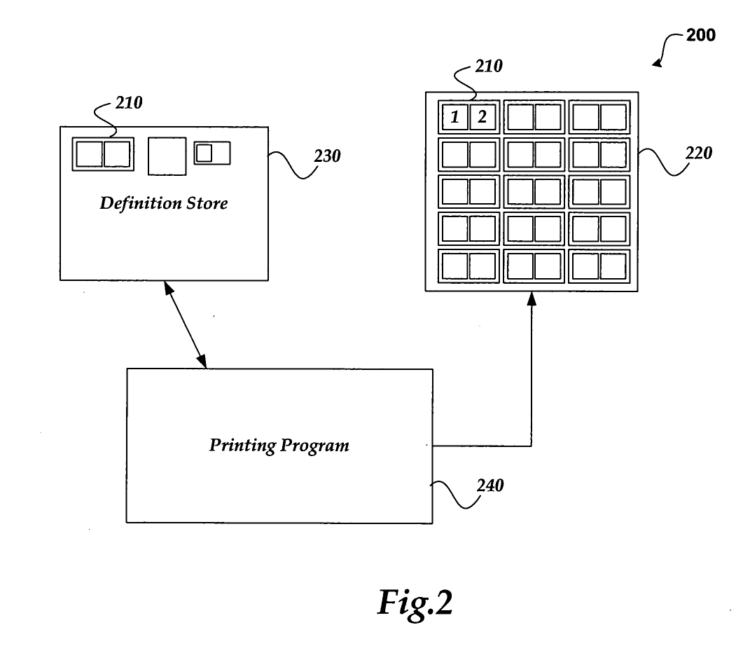

FIG. 2 is a functional block diagram generally illustrating a repeating panel system 200, in accordance with aspects of the invention. As illustrated, system 200 includes printing program 240, definition store 230, sheet 220, and repeating panel set 210. Printing program 240 may be run on many different computing devices. For example, printing program 240 may run on a computing device as described in conjunction with FIG. 1.

Definition store 230 is configured to store the definitions for the panel sets relating to the paper products that are available from various paper manufacturers. Instead of storing positioning information for each panel set within the sheet, a single panel set is defined and stored. This single definition of the panel set may then be repeated (tiled) across and down the sheet. For example, referring to sheet 220, although there are fifteen panel sets included on the sheet, printing program 240 used a single definition of panel set 210 to tile the entire sheet. In this way, if the sheet size changes, a new definition for the sheet is not required. In this example, two panels (1 and 2) are included within a sheet grid making up the panel set (210). Each of the panels (1 and 2) reference a master panel that provides the definition for the panel (see description below). In this way, only a single definition of a panel is required even though the panel is positioned on the sheet many times.

Although definition store 230 is shown separately from printing program 240, the definition store may reside anywhere. For example, the definition store may reside in RAM, ROM, a disk drive, or any other type of computer memory. The definitions may also be stored on a separate computer from printing program 240. For example, the panel set definitions could be maintained on a server that is accessed by printing program 240 when needed. The server could be based on any network, internal or external to printing program 240. In this way, the definitions would be stored at a central location allowing updates to be more easily made to the panel set definitions. The definition store could be arranged many different ways, including as a database, a spreadsheet, a delimited file, and the like.

Printing program 240 is a program that interacts with panel sets. According to one embodiment, printing program 240 is a program such as Microsoft Publisher or Microsoft Word created by Microsoft Corporation based in Redmond, Wash. Printing program 240 is configured to access a definition of a panel set and use the definition to tile a sheet with the panel set using the printable space of the page. As illustrated in FIG. 2, printing program 240 accessed the definition of panel set 210 and produced sheet 220 having fifteen panel sets tiled on it.

Typically, a paper manufacturer provides definitions for their paper products that they would like supported by printing program 240. According to one embodiment, the panel sets relating to the products are defined using XML (See FIGURES and related discussion below). Defining the panel sets using an XML schema provides a standardized way of accessing and defining the panel sets. According to other embodiments, the panel sets may be defined others ways. For example, the panel sets could be described within data structures that are included within the code of printing program 240.

Defining Panel Sets in an External Data Store

Paper Manufacturers, Label makers, and even users may create panel set definitions for their products in an external data store. According to one embodiment, the panel set definitions are stored as XML. The definitions may be stored in many different types of data stores, including a database, a spreadsheet, a delimited file, and the like. When the definitions are stored externally, the printing program may access the latest definitions without having to be recompiled. Some examples will help in illustrating defining panel sets relating to paper products. Although the examples illustrated use XML for the definitions, the definitions may be stored in other ways.

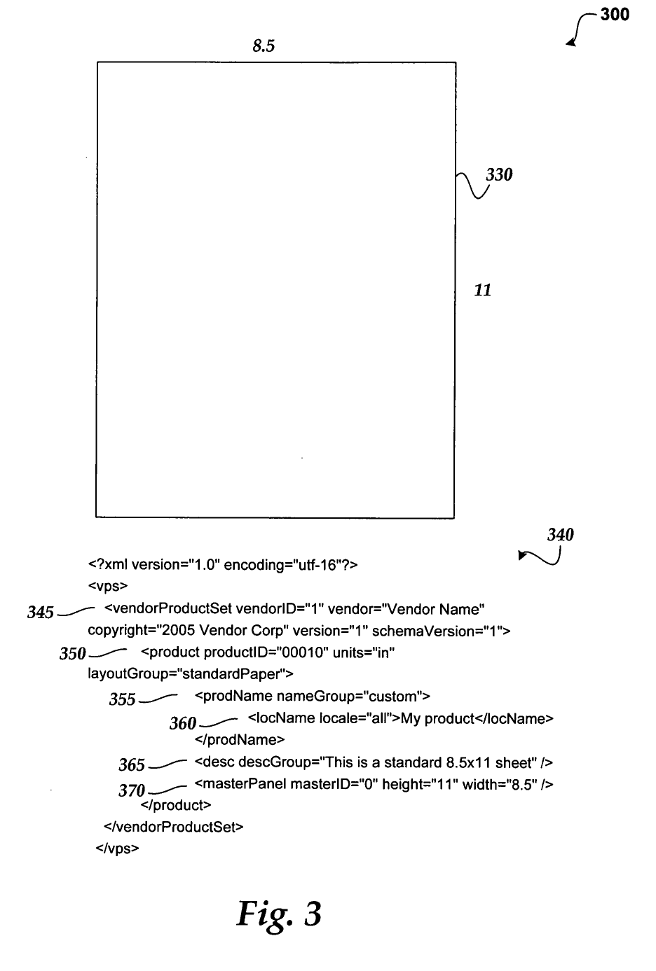

FIG. 3 shows a basic XML description for standard paper, in accordance with aspects of the invention. As illustrated, FIG. 3 includes master panel 330 that is defined by XML 340. The following XML describes a standard paper product.

<?xml version=“1.0” encoding=“utf-16”?>
<vps>

<vendorProductSet vendorID=“1” vendor=“Vendor Name”
copyright=“2005 Vendor

Corp” version=“1” schemaVersion=“1”>

<product productID=“00010” units=“in”
layoutGroup=“standardPaper”>

<prodName nameGroup=“custom”>

<locName locale=“all”>My product</locName>

</prodName>
<desc desc=“This is a standard 8.5×11 sheet” />
<masterPanel masterID=“0” height=“11” width=“8.5” />

</product>

</vendorProductSet>

</vps>

The <vps> is the root node for the XML.

The vendorProductSet element (345) contains attributes relating to the vendor of the product. According to one embodiment, all of the product definitions from the same vendor are stored together. The vendorID attribute is a unique identifier that is associated with the vendor. The vendor attribute is the name as the vendor would like it to be displayed within the template catalog associated with the publishing program. The copyright attribute tracks the copyright date. The version attribute identifies the version of the product. The schemaVersion attribute identifies the version of the schema to which the definition is written.

The product element (350) identifies the product. The productID attribute is an integer that the publishing program uses to manipulate this product. The productID uniquely identifies each of the vendor's products. According to one embodiment, the product IDs may be generated in real time by the program as needed. The units attribute identifies the unit of measurement used in defining the product. In this example, for instance, the unit attribute is set to inches. Other units may also be used. For example, cm, mm, emu, and the like may be used. The layoutGroup attribute is used by the publishing program to determine what other definitions should be displayed with this definition. Some exemplary values for the layoutGroup attribute, include, but are not limited to: standardPaper; advertisement; banner; binderDivider; booklet; businessCard; designedStandardPaper; email; envelope; greetingCard; mailingLabel; mediaLabel; nametag; otherLabel; photoPaper; poster; smallPublication; and web.

The prodName element (355) represents the name of the product. Generally, the nameGroup provides vendors with a list of names and descriptions for products that will be localized based on the user's location.

The locName element (360) is the product name if the nameGroup is set to “custom.” The locale attribute identifies which locale this locName belongs to, such as: en-us; en-gb; de-de; all, and the like.

The desc element (365) provides a way for a definition of the product to be included within the XML. In this example, the description merely states that this is a standard 8.5×11 sheet.

The masterPanel element (370) is the size of the page that is displayed by the publishing program. Generally, the masterPanel element is the size of the individual design area (i.e. the size of the business card, label, brochure, or poster). For example, a standard US business card could be defined as follows:

<product productID=“20000” units=“in” layoutGroup=“businessCard”>

<prodName nameGroup=“sizeUS” />
<desc descGroup=“” />
<masterPanel masterID=“0” height=“2” width=“3.5” />

</product>

The masterID attribute within the masterPanel element is a unique ID. Some products may have multiple masterPanels. The height attribute is the height of the masterPanel. The width attribute is the width of the master panel.

According to one embodiment, a list of localized names and descriptions for products is included within the definitions. This provides the vendors with a list of commonly used names and descriptions such that the vendor does not need to spend time localizing all of the names. Should the vendor wish to use on the included names, the descGroup attribute or the nameGroup attribute is set to one of the values listed below. The attributes may also be set to “custom” should the vendor desire to set their one name and group. When the attribute is set to custom, then one or more locName and locDesc elements are included within the XML such that the publishing program knows how to interpret the names based on the locality. Some exemplary nameGroup attributes, include: standardPaper; advertisement; banner; binderDivider; booklet; brochure; businessCard; businessForm; calendar; catalog; designedStandardPaper; email; envelope; flyer; giftCertificate; greetingCard; importWordDocument; invitationCard; indexCard; letterhead; mailingLabel; mediaLabel; menu; nametag; newsletter; otherLabel; paperFoldingProject; photoPaper; postcard; poster; program; report; resume; rotaryCard; sign; sticker; tentCard; withComplimentsCard; and web. Some exemplary descGroup attributes include: standardPaper; a3; a4; a4LS; a5; a5LD; b4; b4JIS; b5; b5JIS; b5; b6JIS; c; d; e; vertHalfSheet; vertHalfSheetLS; higaki; higakiLS; executive; legal; letter; letter LS; square; tabloid; ledger; folio; quarto; p10×14; p11×17; usStandardFanfold; germanStandardFanfold; germanLegalFanfold; mini; prc16Kai; prc32Kai; prcBig32Kai; advertisement; squareAdvertisement; tallAdvertisement; wideAdvertisement; banner; wideBanner; tallBanner; binderDivider; 5TabBinderDivider; 8TabBinderDivider; 10TabBinderDivider; 12TabBinderDivider; 15TabBinderDivider; Booklet; halfStandardPaperBooklet; standardPaperBooklet; brochure; brochure2FoldStandard; brochure2FoldWide; brochure3FoldStandard; brochure3FoldWide; brochure4FoldStandard; brochure4FoldWide; businessCard; verticalBusinessCard; horizontalBusinessCard; horizontal2SidedBusinessCard; verticalFoldedBusinessCard; horizontalFoldedBusinessCard; verical2SidedBusinessCard; horizontal2SidedFoldedBusinessCard; vertical2SidedFoldedBusinessCard; businessForm; horizontalBusinessForm; verticalBusinessForm; calendar; wallCalendar; walletCalendar; catalog; designedStandardPaper; email; envelope; n9E; n10E; n11E; n12E; n14E; d1Envelope; c5Envelope; monarchEnvelope; personalEnvelope; c3Envelope; c4Envelope; c55Envelope; b4Envelope; b5Envelope; b6Envelope; italianEnvelope; cardEnvelope; letterEnvelope; flyer; giftCertificate; greetingCard; quarterFoldTopGreetingCard; quarterFoldSideGreetingCard; halfFoldSideGreetingCard; importWordDocument; invitationCard; indexCard; letterhead; mailingLabel; addressMailingLabel; returnAddressMailingLabel; shippingMailingLabel; mediaLabel; CDDVDFaceMediaLable; CDDVDCaseMediaLabel; CDDVDSpineMediaLabel; cassetteFaceMediaLabel; cassetteSpineMediaLabel; computerDiskMediaLabel; videoFaceMediaLabel; videoSpineMediaLabel; menu; nametag; nameBadge; iDCard; newsletter; standardPaperNewsletter; tabloidNewsletter; broadsheetNewsletter; otherLabel; bookplateLabel; jarLabel; paperFoldingProject; photoPaper; 4×6PhotoPaper; 5×7PhotoPaper; 8×10PhotoPaper; walletPhotoPaper; postcard; poster; program; report; resume; rotaryCard; sign; sticker; tentCard; placeCard; smallTentCard; mediumTentCard; largeTentCard; withComplimentsCard; web; 640wideweb; 800wideweb; 1024wideweb; and 1200wideweb.

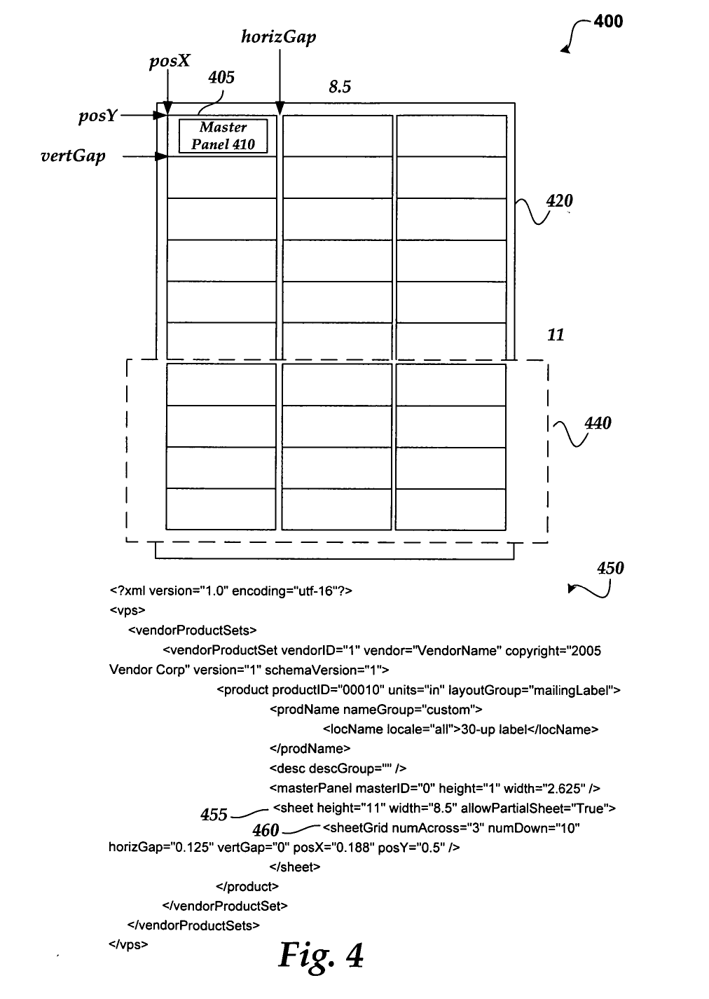

FIG. 4 illustrates defining grids of master panels, in accordance with aspects of the present invention. Grids may be defined using a sheet element and a sheetGrid element. The sheet and sheetGrid elements are typically used for defining grids of labels, business cards, and the like, that print onto a single sheet.

For example, the following XML (450) defines a grid of mailing labels printed onto a standard 8.5×11 sheet.

<?xml version=“1.0” encoding=“utf-16”?>
<vps>

<vendorProductSets>

<vendorProductSet vendorID=“1” vendor=“VendorName”
copyright=“2005

Vendor Corp” version=“1” schemaVersion=“1”>

<product productID=“00010” units=“in”
layoutGroup=“mailingLabel”>

<prodName nameGroup=“custom”>

<locName locale=“all”>30-up label</locName>

</prodName>
<desc descGroup=“” />
<masterPanel masterID=“0” height=“1”
width=“2.625” />
<sheet height=“11” width=“8.5”
allowPartialSheet=“True”>

<sheetGrid numAcross=“3” numDown=“10”

horizGap=“0.125” vertGap=“0” posX=“0.188” posY=“0.5” />

</sheet>

</product>

</vendorProductSet>

</vendorProductSets>

</vps>

The sheet element (455) is a description of the sheet. According to one embodiment, the sheet element (455) can be omitted if the masterPanel element defines the sheet. The sheet element is included within the XML definition when there is a sheetGrid element and/or when background attributes associated with the paper are set. The height attribute is the height of the sheet. According to one embodiment, all of the measurements within the XML definition for the product are defined by the product's unit definition which is defined within the product element by the units attribute. The width attribute is the width of the sheet. The allowPartialSheet attribute allows the user to only print a portion of the sheet even though the entire sheet is defined. For example, the user may express a desire to only print 10 of the 30 mailing labels. In this case, the default is to print the first 18 labels on the sheet. According to one embodiment, the labels illustrated in box 440 would not be printed when the user selects to print the first eighteen labels. Alternatively, the user could individually select the labels to print or enter the starting number. For instance, the user could select to print labels 1, 8, 12 and 16. This selection could be made many different ways. For example, the user could select the labels to print through a graphical user interface showing a preview of the labels or the user could enter the labels to print within a dialog box. According to one embodiment, the allowPartialSheet attribute may be set to True or False. When set to false, the user is not provided with the option to print only a partial sheet of labels.

The sheetgrid element (460) is used to arrange grid cells (405) which generally contain at least one masterPanel (410) on the sheet (420). The master panels may use all or part of the grid cell. The numAcross attribute is the number of masterPanels that fit across the sheet. If the numAcross attribute is not set, the default is tile as many grid cells across the sheet as possible based on the size of the sheet being printed. In the present example, the numAcross element is set to the maximum number of master panels that would fit across sheet 420. Similarly, the numDown attribute is the number of grid cells that may fit down the sheet. The default, if not specified, is to tile as many grid cells down the sheet as possible. The horizGap attribute is the horizontal distance between the edges of labels. According to one embodiment, the default is no gap. The vertGap attribute is the vertical distance between the edges of labels. According to one embodiment, the default is no gap. The posX attribute is the absolute horizontal position from the top-left of the top-left corner of first grid cell. The posY attribute is the vertical position from the top-left of the top-left corner of first grid cell.

According to one embodiment, the sheet element may also include a picture attribute as well as a color attribute (not shown). Some paper has a pre-printed background or is of a different color. In order to display a representative preview, the color of the sheet may be stored within the XML. The following is an example, setting the background color of the sheet. Other settings associated with the sheet may also be included depending on the specific characteristics of the sheet.

<sheet height=“11“ width=“8.5“ bgImage=”C:\Program Files\My Paper
Company\Paper1.jpg” bgColor=”#FF00FF” />

As can be seen from the example, the bgImage value is a URI value referencing a background image for the sheet. The bgColor value is a six-character HTML-style Hex string defining color. Although the above example shows the Image located on the local machine, the Image may also be located at a network location. The image may be located anywhere as long as the location may be defined.

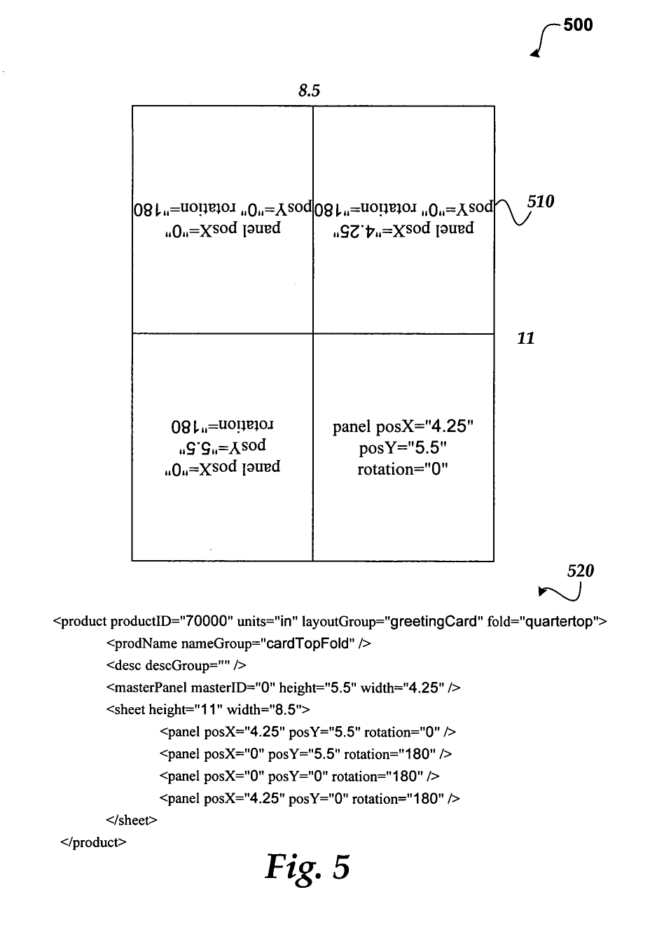

FIG. 5 shows a definition for a greeting card, in accordance with aspects of the present invention. The following XML (520) defines a greeting card having a quarter top fold, in accordance with aspects of the invention.

<product productID=“70000” units=“in” layoutGroup=“greetingCard”
fold=“quartertop”>

<prodName nameGroup=“cardTopFold” />
<desc descGroup=“” />
<masterPanel masterID=“0” height=“5.5” width=“4.25” />
<sheet height=“11” width=“8.5”>

<panel posX=“4.25” posY=“5.5” rotation=“0” />
<panel posX=“0” posY=“5.5” rotation=“180” />
<panel posX=“0” posY=“0” rotation=“180” />
<panel posX=“4.25” posY=“0” rotation=“180” />

</sheet>

</product>

As can be seen by referring to FIG. 5, a single master panel was defined that was then rotated and positioned using absolute positioning within a sheet. If the sheet was large enough, greeting card 510 could be tiled when the sheet was printed.

The following XML illustrates some more definitions for various products defining panel sets. The following XML represents a business card that is common in Europe. As can be seen, this business car includes margin attributes as well as cell height and width attributes.

```
<product productID=“20010” units=“cm” layoutGroup=“businessCard”>
  <prodName nameGroup=“sizeEurope” />
  <desc descGroup=“” />
  <masterPanel masterID=“0” height=“2.165” width=“3.346”
  leftMargin=“.25”
rightMargin=“.25” topMargin=“.25” bottomMargin=“.25” />
  <sheet height=“11” width=“8.5”>
```

<sheetGrid posX=“.5” posY=“1” numAcross=“2” numDown=“3”

vertGap=“1.25” horizGap=“.5” cellHeight=“2.165” cellWidth=“3.346” />
</sheet>
</product>

The following XML illustrates another greeting card panel set that is a card side fold.

<product productID=“70010” units=“in” layoutGroup=“greetingCard”
fold=“quarterside”>

<prodName nameGroup=“cardSideFold” />
<desc descGroup=“” />
<masterPanel masterID=“0” height=“5.5” width=“4.25” />
<sheet height=“11” width=“8.5”>

<panel posX=“4.25” posY=“5.5” rotation=“0” />
<panel posX=“4.25” posY=“0” rotation=“180” />
<panel posX=“0” posY=“0” rotation=“180” />
<panel posX=“0” posY=“5.5” rotation=“0” />

</sheet>

</product>

Although not shown, any shape may be included within a sheet grid area. For example, a panel may be a round panel and be defined, for instance, using a radius and positioned using the center of the circle.

Similarly, a cutout and fold may be defined within the panel set such that the user is not allowed to place text or graphics within the material at the location of the cutouts and/or folds within the material. Additionally, paper cutting equipment could use the cutout definition to determine where to cut the material. Similarly, paper folding equipment could use the fold definition to determine where to fold the material. The following XML schema illustrates a cutout and folds element according to one embodiment of the invention.

<xs:element name=“foldLine” minOccurs=“0” maxOccurs=“unbounded”>

<xs:complexType>

<!-- Attributes for foldLine -->
<xs:attribute name=“direction” use=“required”>

<xs:simpleType>

<xs:restriction base=“xs:string”>

<xs:enumeration value=“horizontal” />
<xs:enumeration value=“vertical” />

</xs:restriction>

</xs:simpleType>
</xs:attribute>

<xs:attribute name=“offset” use=“required” type=“xs:float” />
<!-- offset is from top or left -->

</xs:complexType>

</xs:element>
<xs:element name=“cutout” minOccurs=“0” maxOccurs=“unbounded”>

<xs:complexType>

<!-- Attributes of cutout -->
<!-- posX and PosY of cutout denote the position from top

left of the masterPanel to the top left of the cutout -->

<xs:attribute name=“posX” use=“required” type=“xs:float” />
<xs:attribute name=“posY” use=“required” type=“xs:float” />
<xs:attribute name=“height” use=“required” type=“xs:float” />
<xs:attribute name=“width” use=“required” type=“xs:float” />
<xs:attribute name=“shape” use=“optional”>

<xs:simpleType>

<xs:restriction base=“xs:string”>

<xs:enumeration value=“ellipse” />
<xs:enumeration value=“rect” />

</xs:restriction>

</xs:simpleType>
</xs:attribute>
</xs:complexType>
</xs:element>

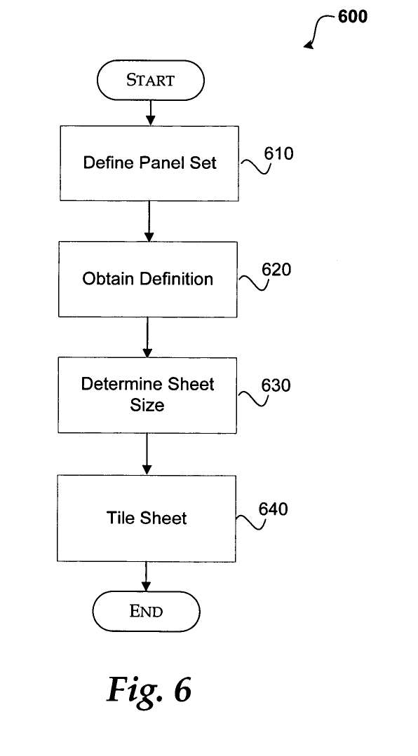

FIG. 6 illustrates a process for tiling a sheet with repeating panels, in accordance with aspects of the invention. After a start block, the process flows to block 610 where the panel sets are defined. Typically, the panel sets relate to the paper products available from paper manufacturers. For instance, a panel set could relate to a business card, a mailing label, a CD spine and label, a postcard, a greeting card, and the like.

Moving to block 620, the definition of the panel set is obtained when needed by a program, such as a publishing program. The definition of the panel set defines the locations of the panels within the panel set.

Flowing to block 630, the sheet size is determined. The sheet size is used to determine how many times the panel set may be repeated on the sheet. For example, a business card may be repeated many more times on a legal size sheet as compared to a standard 8.5×11 piece of paper.

Moving to block 640, the sheet is tiled using the definition of the panel set. According to one embodiment, the user may determine what panels to print on the page. For example, the user may only desire to print half of the panels that could potentially be printed on a sheet. Similarly, the user could desire to start printing the panel sets starting with the fourth panel down on the sheet.

The process then flows to an end block and returns to processing other actions.

Illustrative Operating Environment

With reference to FIG. 1, one exemplary system for implementing the invention includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 may include a printing program 120. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 may also contain communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for representing repeating panels, comprising:
defining a master panel;
defining a sheet grid area;
defining a panel set within the sheet grid area, wherein the panel set defines a position for at least one panel that is defined by the master panel; and
tiling a sheet by repeating the defined sheet grid area that includes the panel set.

2. The method of claim 1, wherein defining the master panel comprises setting a height and a width associated with the master panel.

3. The method of claim 1, wherein defining the master panel, defining the sheet grid area and defining the panel set comprises storing the definition of the master panel, the sheet grid area and the panel set as at least one of: XML; a relational database; and a delimited file.

4. The method of claim 1, wherein defining the sheet grid area comprises setting a position of the sheet grid area within the sheet.

5. The method of claim 1, wherein any panels within the panel set may be positioned using absolute positioning.

6. The method of claim 1, wherein tiling the sheet comprises determining a size for the sheet; determining the number of sheet grid areas that fit within the size of the sheet; and tiling the sheet with the determined number.

7. The method of claim 1, wherein tiling the sheet further comprises determining where on the sheet to begin tiling.

8. A computer-readable medium having computer-executable instructions for representing repeating panels, comprising:
defining a sheet grid area;
defining a panel set within the sheet grid area, wherein the panel set defines includes at least one panel that is positioned within the sheet grid area, wherein the panel set may include at least one of a cutout and a fold; and
tiling the sheet grid area on a sheet.

9. The computer-readable medium of claim 8, further comprising defining a master panel by setting a dimension attribute, wherein the panel that is positioned within the sheet grid area obtains its dimension information from the master panel.

10. The computer-readable medium of claim 8, wherein defining the master panel, defining the sheet grid area and defining the panel set comprises storing the definition of the master panel, the sheet grid area and the panel set as at least one of: XML; a relational database; and a delimited file.

11. The computer-readable medium of claim 8, further comprising defining a number of times the sheet grid area should be tiled.

12. The computer-readable medium of claim 8, wherein the panel positioned within the sheet grid area is positioned using absolute positioning.

13. The computer-readable medium of claim 8, wherein tiling the sheet comprises determining a size for the sheet; determining the number of sheet grid areas that fit within the size of the sheet; and tiling the sheet with the determined number.

14. The computer-readable medium of claim 9, wherein the dimension attribute may be selected from at least one of: a height; a width; a diameter; a radius; and a diagonal.

15. An apparatus for representing repeating panels, comprising:
a data store that is configured to store definitions relating to a panel set; and
a processor configured to perform actions, including:
accessing a master panel definition;
accessing a sheet grid area definition;
accessing a defined panel set that is defined to be within the sheet grid area, and
tiling a sheet by repeating the defined sheet grid area that includes the panel set.

16. The apparatus of claim 15, wherein accessing the master panel definition comprises obtaining dimension information the master panel.

17. The apparatus of claim 15, wherein the master panel, the sheet grid area and the panel set are represented by at least one of: XML; a relational database; and a delimited file.

18. The apparatus of claim 17, wherein accessing the sheet grid area comprises obtaining a position of the sheet grid area relative to the sheet.

19. The apparatus of claim 17, wherein any panels within the panel set are positioned within the sheet grid area using absolute positioning.

20. The apparatus of claim 19, wherein tiling the sheet comprises determining a size for the sheet; determining the number of sheet grid areas that fit within the size of the sheet; and tiling the sheet with the determined number.
